(19) United States
(12) Patent Application Publication
(10) Pub. No.: US 2025/0019301 A1
(43) Pub. Date: Jan. 16, 2025

(54) PROCESS FOR ACTIVATING CLAYS WITH HIGH RESIDUAL MOISTURE

(71) Applicant: KHD HUMBOLDT WEDAG GMBH, COLOGNE (DE)

(72) Inventors: Marc FEISS, KÖLN (DE); Rolf GUSSMANN, KÖLN (DE); Norbert STREIT, SIEGBURG (DE)

(21) Appl. No.: 18/705,392

(22) PCT Filed: Oct. 5, 2022
(86) PCT No.: PCT/EP2022/077648

§ 371 Date: Apr. 26, 2024

(30) Foreign Application Priority Data
Oct. 28, 2021 (DE) 102021128060.5

(51) Int. Cl. C04B 7/12; C04B 7/36; C04B 7/40; C04B 7/45; C04B 7/47; F27B 15/00; F27D 3/00; F27D 13/00; F27D 17/00

(52) U.S. Cl. CPC C04B 7/12; C04B 7/364; C04B 7/40; C04B 7/45; C04B 7/475; F27B 15/00; F27D 3/0033; F27D 13/005; F27D 17/004; F27D 2003/0071; F27M 2003/03

(57) ABSTRACT

A process for activating clays having high residual moisture by: feeding wet clay into a device for drying, comminuting the previously dried clay in a device for comminuting, thermally activating the comminuted clay in an entrained flow reactor or in a fluidized bed reactor in which the comminuted clay is in suspension in a hot gas, removing the gas from the entrained flow reactor or the fluidized bed reactor in a device for removing, and cooling the thermally activated clay in a device for cooling with a cooling gas, and to a corresponding plant. The cooling gas, heated after cooling the thermally activated clay, is combined with the gas from the reactor, and the combined gases are introduced into the drying device. The drying air is filtered after drying, and clay removed by filtration is unified with the dried clay.

### CROSS-REFERENCES TO RELATED APPLICATIONS

This application is a national phase of International Patent Application No. PCT/EP2022/077648, filed on Oct. 5, 2022, which claims the benefit of German Patent Application No. 10 2021 128 060.5, filed on Oct. 28, 2021, the entire disclosures of which are incorporated herein by way of reference.

### FIELD OF THE INVENTION

The invention relates to a process for activating clays having high residual moisture, comprising the following steps: feeding wet clay into a device for drying, comminuting the previously dried clay in a device for comminuting, thermally activating the comminuted clay in an entrained flow reactor or in a fluidized bed reactor in which the comminuted clay is in suspension in a hot gas, removing the gas from the entrained flow reactor or the fluidized bed reactor in a device for removing, and cooling the thermally activated clay in a device for cooling with a cooling gas, and to a corresponding plant.

### BACKGROUND OF THE INVENTION

As a substitute for cement clinker as building material it is known practice to employ thermally activated clay. While thermally activated clays do not attain the strength of concrete based on cement clinker, the properties of activated clays as construction material are nevertheless sufficient for a multiplicity of building projects where performance of the building material is not a particular factor, as is the case, for example, with prestressed concrete bridges or as is the case with extremely high high-rise blocks well above the 100 m limit.

Edifices made of clays have been known since antiquity. Houses of fired clays and mud exhibit the typical reddish coloration, which may extend to the hue of terracotta tiles.

Clay minerals suitable for processing as building material, which develop hydraulic properties through thermal treatment, referred to as thermal activation, may vary greatly in their chemical and mineralogical compositions and also in their physical properties. Natural sources of these clay minerals include not only the clay minerals but also, in general, various fractions of constituents that are inert in respect of the hydraulic properties, such as quartz, feldspar and flint, for example. Clay materials of purely natural origin with different provenances differ generally in various properties such as particle size, density and moisture content, for instance. As well as in these extrinsic properties, clay minerals with different provenances differ in inorganic impurities they contain, such as iron, titanium and manganese.

Clay is a naturally occurring material which consists primarily of clay mineral particles, generally has plastic deformability at sufficient water content, and becomes brittle when dried or fired. While clay generally includes phyllosilicates, it may include other materials which give it plasticity and which harden when they are dried or fired. Clay may comprise materials, in the form of associated phases, which do not give it plasticity, examples being quartz, calcite, dolomite, feldspar and also organic substances.

In contrast to earlier definitions, a definition by the AIPEA (Association Internationale Pour L'Etude Des Argiles) and the CMS (Clay Minerals Society) does not specify an exact grain size of the clay constituents, as different disciplines have made their own specifications here. In the geosciences, in accordance with Standard EN ISO 14688, clay particles are deemed to be particles which have a lower grain size than 2 μm (in some cases also less than 4 μm), and in colloid chemistry clay particles are deemed to be particles having a grain size below 1 μm.

In the context of this patent application, clays are understood as the naturally occurring material which either consists primarily of clay mineral particles, thus having more than 50% of clay mineral particles, but also those materials, which can be mined from clay deposits, which have less than 50% of clay mineral particles down to only 10% to 20% of clay mineral particles. The grain size of the clay particles here is intended for the most part to be less than 4 μm. The remainder consists of sand, silt, quartz, calcite, dolomite, feldspar and also, possibly, gravel. The large fractions of material which do not represent clay mineral particles are virtually chemically inert and abrasive and are thermally inactivatable. The latter clays therefore resemble mud.

In their natural deposits, clays generally occur with a high moisture. The moisture gives the clays a certain plasticity. Some clays, when mined from their deposits, have a pasty quality and also a certain adhesion. In the context of this patent application, clays having high residual moisture are understood as those clays which when mined have plastic properties, form a pulpy to pasty mass and exhibit a propensity towards caking. On drying, these clays lose these properties until they become brittle and exhibit a propensity towards caking. In this state, having undergone drying to form dry lumps, however, a clay does not as yet have distinct hydraulic binder properties, or has them only to a small extent. The hydraulic binder properties are developed only through thermal activation, in which water of hydration as well escapes from the clay minerals.

In light of the above-described material properties of clays having high residual moisture, a direct further processing (storage, comminution, transport, metering) without prior drying is completely impossible or possible only with high technical outlay. With regard to materials handling, the conveying of the material with customary apparatus for bulk products is virtually impossible, since the clays clog and block up the apparatus. In order to keep the transport pathways for freshly mined clay short and to avoid materials handling problems, clay drying is usually located immediately downstream of clay delivery. From there, the pathway to onward processing is generally relatively long. The utilization of process heat from a downstream operating step is made more difficult firstly because the process heat has to be transported over more substantial distances and secondly owing to a frequent nonavailability of suitable heat sources as needed to dry the clay having high residual moisture. The drying of clays having high residual moisture requires a large quantity of heat. Available process heat is subdivided in the industry into high-grade and low-grade process heat. The high-grade process heat has a high temperature, generally above 800° C. Low-grade process heat generally has a temperature below 300° C. However, the terms ‘high-grade’ and ‘low-grade’ say relatively little about the available quantity of heat. A low-grade process heat may have a large heat quantity, and a high-grade process heat may also have a low heat quantity, albeit with high temperature. Because the pathway of the drying gas from an available process heat up to clay delivery frequently involves relatively long distances, it is general practice to employ separate hot gas generators for drying the pulpy to pasty clay supplied in a clay dryer. This is because low-grade process heat cannot be effectively transported over sizeable distances, as the temperature drops too sharply by the supply location and the process heat is therefore too cold for efficient drying.

In general it is not possible to use the high-grade process heat from the calcining operation directly, as the gas temperature is too high for an impact hammer mill, for example—the machine protection, the required strengths, the wear and the choice of material do not allow the use of the high-grade process heat. The temperature of the offgases would therefore have to be conditioned for further use either with increased outlay on equipment, in a multi-stage cyclone heat exchanger, and/or by an increase in the gas volume (e.g. by addition of fresh air), but such conditioning has an adverse effect on the machine size and the energy efficiency—for example, electrical energy requirement for fans. Because the pasty properties of the clay break up only at a residual moisture content of less than 10%, generally speaking and depending on consistency and composition, in favor of a dry, pourable quality, drying to below 10% residual moisture content is required. This considerably reduces the energy efficiency when producing an alternative building material with a dedicated hot gas generator for drying the clay at the delivery stage.

### SUMMARY OF THE INVENTION

The object of the invention, therefore, is to provide a process for activating clays having high residual moisture, where handling is facilitated and where a process heat necessary for drying and transporting is available.

The object of the invention may be achieved by a process having the features according one or more embodiments described herein. Additionally, the object may be achieved with a plant for activating clays having high residual moisture according one or more embodiments described herein.

The concept of the invention involves the combination of two process interconnections. The first sees offgas from clay cooling after the thermal activation of clays, as low-grade process heat, being unified with offgases from the thermal activation, as high-grade process heat, and this unified process heat being used for drying the clay at the clay delivery stage. Since a large quantity of dust is produced during clay drying, with the clay already having a very small grain size, indeed, the clay that is removed by filtration in the filtering of the drying offgas is unified with the dried clay. The dried clay has more the consistency of a relatively coarse bulk material, which is readily transportable with conveyor belts and bucket mechanisms. The fines fraction obtained in drying is unified with the coarse fraction and they are passed together into a device for comminuting, before the jointly comminuted fractions are passed on for thermal activation. The fines fraction comprises a high proportion of thermally activatable phyllosilicates, whereas the coarse fraction comprises the admixtures mentioned earlier on, such as sand, silt, quartz, calcite, dolomite, feldspar and also, possibly, gravel. The separation procedure, which is really unwanted in the drying context, is reversed by the unifying prior to comminution. In the joint comminution, the fractions are mixed thoroughly again simultaneously.

### BRIEF DESCRIPTION OF THE DRAWINGS

The invention is elucidated in more detail with reference to the following figures, of which:

FIG. 1 shows a flow diagram of a plant for implementing the process for activating clays having high residual moisture, in a first embodiment, and

FIG. 2 shows a simplified flow diagram representing the process implemented in the plant according to FIG. 1.

### DETAILED DESCRIPTION OF THE PREFERRED EMBODIMENTS

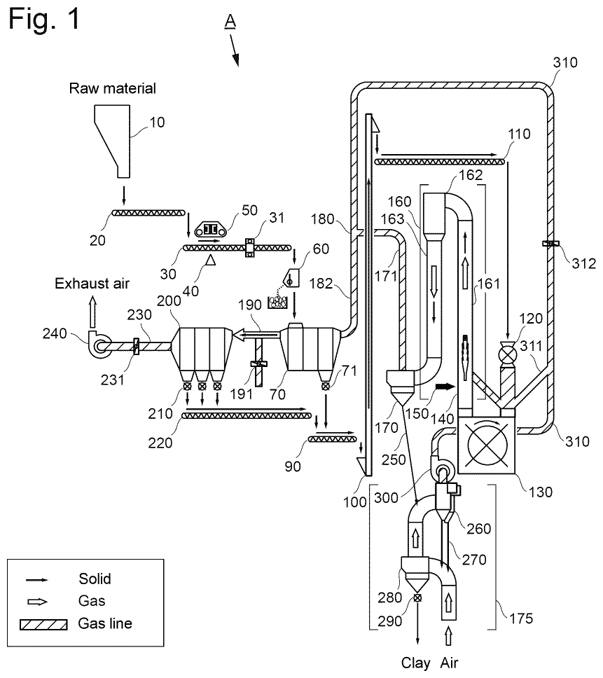

FIG. 1 shows a flow diagram of a plant A for implementing the process for activating clays having high residual moisture, in a first embodiment. In this representation, a linear arrow shows the pathway of solids, while an outlined arrow shows the pathway of gases, as shown in the included key. Raw material in the form of a pasty, plastically deformable to sticky, clay is passed from a feed bunker 10, optionally by means of conveying screws not shown here, to a conveyor belt 20. The raw material drops onto a second conveyor belt 30, which is controlled by a belt weigher 40. The high-moisture-content clay passes first through a magnetic separator 50 for removing metal components which have unintentionally entered the clay, generally machine parts, lost hammer heads, broken-off excavator teeth, and discarded metal, which may enter the clay unintentionally during mining. In a further step, the freshly delivered clay passes through a coarse-material separator 60, which removes coarse stones, small boulders and other non-metallic parts, and also wood and plant constituents. After this first coarse purification, the freshly delivered and pre-cleaned clay drops into a clay dryer 70. This dryer is traversed by a flow of hot gas, which is described in more detail later on below. Drying of the clay is accompanied by a substantial quantity of dust produced, which is discharged with the drying air from the clay dryer 70 via an exhaust air conduit 190.

The dried clay is discharged by a star wheel feeder 71 onto a conveyor belt 90 and raised with a bucket mechanism 100. The bucket mechanism 100 is followed by a further conveyor belt 110 up to a star wheel feeder 120 to an impact hammer mill 130. The conveying referred to here takes place from the delivery of the fresh clay up to the thermal line of the plant. The distances travelled here may amount to several hundred meters. Through the star wheel feeder 120, the dried clay drops into the impact hammer mill 130, which rotates with the rotational direction shown. The hammers of the impact hammer mill 130 spin the comminuted clay off into the ascending branch 140 of an entrained flow reactor 160, in which the clay is thermally activated. For this purpose, the clay suspended in the ascending air of the entrained flow reactor 160 is heated by a burner, which is fed with the fuel supply 150. The clay ascending in the air of the ascending branch 140 is fluidized in the hot gas in a fluidizing chamber 162, where the remaining activation of the clay takes place. After the fluidizing chamber 162 comes the descending branch 163 of the entrained flow reactor 160, where the clay/gas suspension impinges on a cyclone classifier 170. In the cyclone classifier 170, the thermally activated clay is separated from the offgas from the entrained flow reactor 160. The solid, the thermally activated clay, falls through a solids conduit 250 into a clay cooler 175, consisting of a dust separator 260 and a cyclone separator 280. The pathway of the entrained flow reactor 160 offgas removed in the cyclone classifier 170 is followed by the hot gas conduit 171, which leads to a coupling point 180, where the offgas removed from the entrained flow reactor 160 is unified with the offgas from the aforementioned clay cooler 175. The unified offgases flow into the aforementioned clay dryer 70 for drying the fresh clay having high residual moisture. In this process, the offgases used for drying pick up a large quantity of dust. The dust-laden drying air is guided via an exhaust air conduit 190 into a dust filter 200, where the fine, dried clay is deposited. The fine clay deposited is guided via star wheel feeders 210 onto a conveyor belt 220, which guides the fine, dry clay to the conveyor belt 90. There, the fine dried clay is unified with the coarse dried clay from the clay dryer 70. The exhaust air from the dust filter 200 is then discharged by means of a compressor 240 as exhaust air with a temperature of around 150° C. to 200° C.

The thermally activated clay removed in the cyclone classifier 170 falls via a solids conduit 250 into the clay cooler 175, consisting of a dust separator 260 and a cyclone separator 280. The clay cooler 175 is charged with atmospheric air, which is heated as it cools the thermally activated clay and which, as a carrier of low-grade heat, flows firstly via a compressor 300, a gas conduit 310 and a gas conduit 311 into the impact hammer mill 130, where it is available as preheated carrier air for the entrained flow reactor 160. Secondly, a further part of the exhaust air flows from the clay cooler 175 to the coupling point 180, where this exhaust air as a carrier of low-grade heat is unified with the exhaust air from gas line 171, which passes the removed offgas from the entrained flow reactor 160. The unification of the exhaust air from the clay cooler 175 with the high-grade heat in the offgas removed from the entrained flow reactor results in considerable cooling of the offgases removed from the entrained flow reactor, to a temperature between 600° C. and 900° C. However, the unified offgases carry sufficient heat at a temperature which is enough and is not too hot. The thermally activated clay removed from the clay cooler 175 by classification leaves the clay cooler by way of the star wheel feeder 290. The advantage of the process proposed here is that, as a result of the division into drying and comminuting, there is no longer a need for temperature lowering/conditioning. On the offgas side, gas entry temperatures at the dryer of up to 900° C. are realistic and technical feasible. This results in a lower technical outlay, smaller construction sizes and a greater energy efficiency.

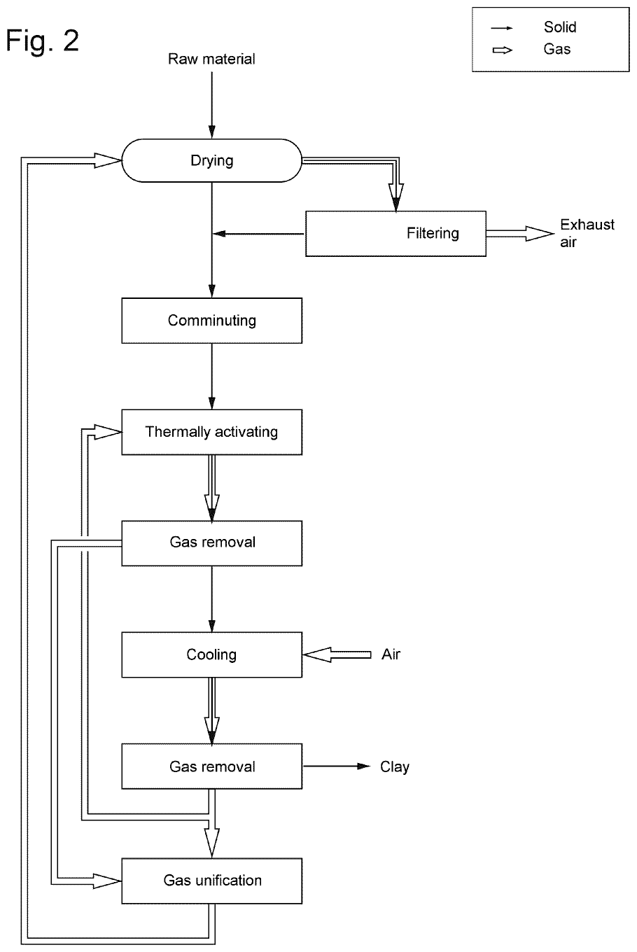

FIG. 2 outlines a simplified flow diagram for representing the process which is implemented in the plant according to FIG. 1. The feeding of the raw material begins in the flow diagram right at the top. This is followed by a drying step. Downstream in the pathway of the solid (linear arrows) there follows a comminuting step. Further downstream of the comminuting step in the path of the solid there follows a thermal activation. Downstream of the thermal activation in the path of the solid there follows a removal of the offgas from the thermal activation step. The solid then passes through a cooling step, and is coupled out of the process in a removal step, as the finished, thermally activated clay. According to the concept of the invention, the air which enters the process in the cooling step is removed after the cooling of the thermally activated clay. Part of the air removed is passed back for the thermal activation. Another part is unified with the offgases removed, which come from the thermal activation, and is passed back for drying. The dust produced in the course of drying is removed by filtration and unified with the freshly dried clay.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SYMBOLS

A Plant
10 Feed bunker
20 Conveyor belt
30 Conveyor belt
40 Belt weigher
50 Magnetic separator
60 Coarse-material separator
70 Clay dryer
71 Star wheel feeder
90 Conveyor belt
100 Bucket mechanism
110 Conveyor belt
120 Star wheel feeder
130 Impact hammer mill
140 Entrained flow reactor
150 Fuel supply
160 Entrained flow reactor
161 Ascending branch
162 Fluidizing chamber
163 Descending branch
170 Cyclone classifier
171 Hot gas conduit
175 Clay cooler
180 Coupling point
182 Conduit
190 Exhaust air conduit
191 Adjustment valve
200 Dust filter
210 Star wheel feeder
220 Conveyor belt
230 Exhaust air conduit
231 Control valve
240 Compressor
250 Solids conduit
260 Dust separator
270 Solids conduit
280 Cyclone separator
290 Star wheel feeder
300 Compressor
310 Cooler exhaust air conduit
311 Gas conduit
312 Adjustment valve

1.-7. (canceled)

8. A process for activating clays having high residual moisture, comprising the following steps:
feeding wet clay into a device for drying the wet clay and configured to provide a dried clay,
comminuting the dried clay in a device for comminuting configured to provide a comminuted clay,
thermally activating the comminuted clay in an entrained flow reactor or in a fluidized bed reactor in which the comminuted clay is in suspension in a gas, the entrained flow reactor or in a fluidized bed reactor configured to provide a thermally activated clay,
removing the gas from the entrained flow reactor or the fluidized bed reactor in a device for removing, and
cooling the thermally activated clay in a device for cooling with a cooling gas,
combining the cooling gas, heated after cooling the thermally activated clay, with the gas from the entrained flow reactor or fluidized bed reactor to provide a combined gas, and
introducing the combined gas into the device for drying as a drying air, and
filtering, in a dust filter, the drying air after drying of the wet clay, wherein clay removed by filtration is combined with the dried clay.

9. The process according to claim 8, wherein the device for comminuting comprises an impact hammer mill.

10. The process according to claim 8, further comprising:
introducing a portion of the cooling gas, heated after cooling the thermally activated clay, into the device for comminuting.

11. The process according to claim 8, further comprising:
introducing a portion of the thermally activated clay obtained on removal of the gas from the entrained flow reactor or the fluidized bed reactor into the device for comminuting.

12. A plant for activating clays having high residual moisture, the plant comprising:
a device for drying a wet clay and configured to provide a dried clay;
a device for comminuting the dried clay and configured to provide a comminuted clay;
an entrained flow reactor or a fluidized bed reactor for thermally activating the comminuted clay, in which the comminuted clay is in suspension in a hot gas, and wherein the entrained flow reactor or the fluidized bed reactor is configured to provide activated clay;
a device for removing gas from the entrained flow reactor or fluidized bed reactor;
a device for cooling the thermally activated clay with a cooling gas;
a device for combining the cooling gas, heated after cooling the thermally activated clay, with the gas from the entrained flow reactor or fluidized bed reactor to provide a combined gas;
a conduit for the combined gas into the device for drying as a drying air;
a device for filtering the drying air after drying of the wet clay; and
a conveying device configured to combine clay removed by the device for filtering with the dried clay.

13. The plant according to claim 12, wherein the device for comminuting comprises an impact hammer mill.

14. The plant according to claim 12, further comprising:
a conduit for heated cooling air which leads from the device for cooling the thermally activated clay to the device for comminuting.
